(19) United States
(12) Patent Application Publication
(10) Pub. No.: US 2026/0326308 A1
(43) Pub. Date: Oct. 22, 2026

(54) DYNAMIC ADAPTATION OF A ROBOTIC SCRUBBING MODULE

(71) Applicant: INTERNATIONAL BUSINESS MACHINES CORPORATION, ARMONK, NY (US)

(72) Inventors: Tushar Agrawal, West Fargo, ND (US); Carolina Garcia Delgado, Zapopan (MX); NEIL DELIMA, Scarborough (CA); Sarbajit Kumar Rakshit, Kolkata (IN)

(21) Appl. No.: 19/181,948

(22) Filed: Apr. 17, 2025

(51) Int. Cl. B25J 11/00; B25J 9/16; B25J 19/02

(52) U.S. Cl. CPC B25J 11/0065; B25J 9/1605; B25J 9/161; B25J 9/1653; B25J 19/022

(57) ABSTRACT

An embodiment for dynamically adapting a robotic scrubbing module is provided. The embodiment may include receiving data from a knowledge corpus and at least one other source in an industrial environment. The embodiment may also include identifying current surface properties of a work product and a robotic scrubbing module. The embodiment may further include based on determining the current surface properties of the work product do not meet pre-determined specifications of a surface profile of the work product, executing one or more virtual simulations. The one or more virtual simulations may compare the current surface properties of the work product with the pre-determined specifications. The embodiment may also include identifying one or more modified parameters of the robotic scrubbing module that achieves the pre-determined specifications. The embodiment may further include causing at least one first device to spray a material onto the robotic scrubbing module.

### BACKGROUND

The present invention relates generally to the field of computing, and more particularly to a system for dynamically adapting a robotic scrubbing module.

Robotic scrubbing systems utilize automated machines equipped with specialized tools to efficiently clean and polish various work products. These systems often employ advanced sensors and algorithms to navigate and target specific areas, ensuring thorough cleaning and precise polishing. The robotic scrubbing process begins with the selection of the appropriate cleaning or polishing agent and then the robotic system applies the cleaning or polishing solution to the surface of a work product, ensuring the effective removal of dirt, grime, and/or other imperfections.

### SUMMARY

According to one embodiment, a method, computer system, and computer program product for dynamically adapting a robotic scrubbing module is provided. The method, computer system, and computer program product may include receiving data from a knowledge corpus and at least one other source in an industrial environment. The method, computer system, and computer program product may also include identifying current surface properties of a work product and current surface properties of a robotic scrubbing module based on the data. The method, computer system, and computer program product may further include based on determining the current surface properties of the work product do not meet pre-determined specifications of a surface profile of the work product, executing one or more virtual simulations of a surface finishing operation by the robotic scrubbing module. The one or more virtual simulations may compare the current surface properties of the work product with the pre-determined specifications. The method, computer system, and computer program product may also include identifying one or more modified parameters of the robotic scrubbing module that achieves the pre-determined specifications based on the one or more virtual simulations. The method, computer system, and computer program product may further include causing at least one first device to spray a material onto the robotic scrubbing module based on the comparison.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for dynamically adapting a robotic scrubbing module in a dynamic robotic scrubbing module adaptation process according to at least one embodiment.

FIG. 3 is an exemplary diagram depicting a work product before and after polishing according to at least one embodiment.

FIG. 4 is an exemplary diagram depicting a knowledge corpus containing various surface profiles of the robotic scrubbing module according to at least one embodiment.

FIG. 5 is an exemplary diagram depicting the robotic scrubbing module polishing the work product according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for dynamically adapting a robotic scrubbing module. The following described exemplary embodiments provide a system, method, and program product to, among other things, identify one or more modified parameters of the robotic scrubbing module that achieves pre-determined specifications of a surface profile of a work product based on one or more executed simulations and, accordingly, cause at least one first device to spray a material onto the robotic scrubbing module based on a comparison between current surface properties of the work product with the pre-determined specifications of the surface profile of the work product. Therefore, the present embodiment has the capacity to improve industrial technology by dynamically adapting a scrubbing module of a robotic system to optimize a surface finish of a work product.

As previously described, robotic scrubbing systems utilize automated machines equipped with specialized tools to efficiently clean and polish various work products. These systems often employ advanced sensors and algorithms to navigate and target specific areas, ensuring thorough cleaning and precise polishing. The robotic scrubbing process begins with the selection of the appropriate cleaning or polishing agent and then the robotic system applies the cleaning or polishing solution to the surface of a work product, ensuring the effective removal of dirt, grime, and/or other imperfections. The effectiveness of scrubbing is typically reduced during the scrubbing operation. For example, similar to how a knife dulls over time due to frequent use, the robotic scrubber module may also naturally dull over time. This problem is typically addressed by replacing the robotic scrubbing module when dull. However, continuously replacing the robotic scrubbing module is costly and delays the scrubbing operation.

It may therefore be imperative to have a system in place to enable a robotic scrubbing module to dynamically adapt and correct itself to an optimal grit level based on specific requirements. Thus, embodiments of the present invention may provide advantages including, but not limited to, dynamically adapting a scrubbing module of a robotic system to optimize a surface finish of a work product, maintaining an optimal grit level based on specific requirements, and obtaining high quality cleaning and polishing results in industrial settings. The present invention does not require that all advantages need to be incorporated into every embodiment of the invention.

According to at least one embodiment, on an assembly line, data from a knowledge corpus and at least one other source in an industrial environment may be received in order to identify current surface properties of a work product and current surface properties of a robotic scrubbing module based on the data. Upon identifying the current surface properties of the work product and the current surface properties of the robotic scrubbing module, it may be determined whether the current surface properties of the work product meet pre-determined specifications of a surface profile of the work product. Based on determining the current surface properties of the work product do not meet the pre-determined specifications, one or more virtual simulations of a surface finishing operation by the robotic scrubbing module may be executed where the one or more virtual simulations may compare the current surface properties of the work product with the pre-determined specifications. Then, one or more modified parameters of the robotic scrubbing module that achieves the pre-determined specifications may be identified based on the one or more virtual simulations so that at least one first device may be caused to spray a material onto the robotic scrubbing module based on the comparison.

According to at least one embodiment, the one or more modified parameters may include a modified grit (e.g., roughness) level of the robotic scrubbing module. According to at least one other embodiment, the one or more modified parameters may include a modified force, rotational speed, and/or velocity at which the robotic scrubbing module performs the one or more scrubbing operations. In either embodiment, at least one second device may be caused to emit a laser beam onto the sprayed material based on the one or more modified parameters, where the at least one first device and the at least one second device may collaborate with each other to achieve the pre-determined specifications. Upon emitting the laser beam, one or more scrubbing operations may be performed on the work product according to the one or more modified parameters.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to identify one or more modified parameters of the robotic scrubbing module that achieves pre-determined specifications of a surface profile of a work product based on one or more executed simulations and, accordingly, cause at least one first device to spray a material onto the robotic scrubbing module based on a comparison between current surface properties of the work product with the pre-determined specifications of the surface profile of the work product.

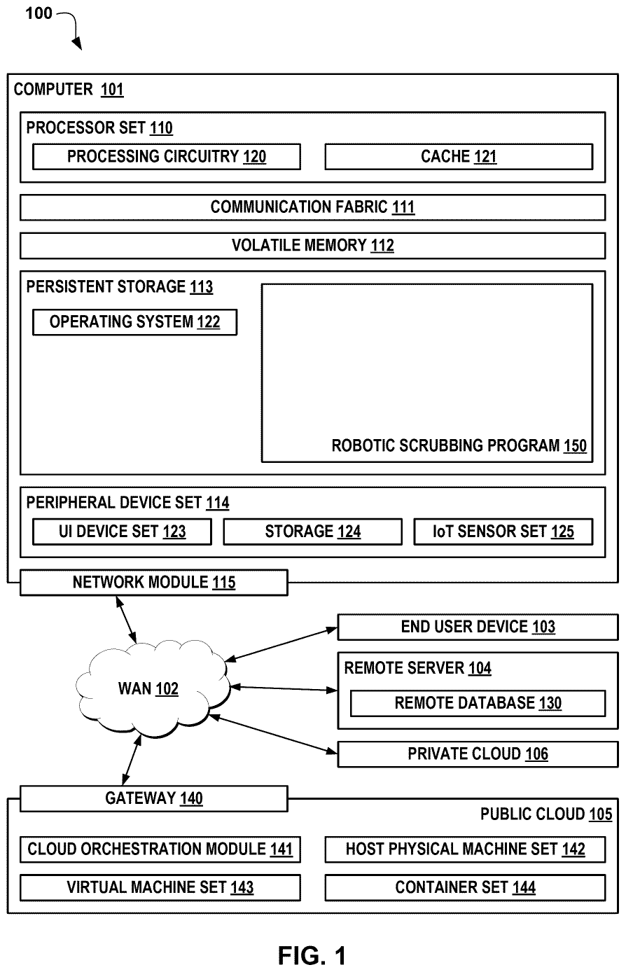

Referring to FIG. 1, an exemplary computing environment 100 is depicted, according to at least one embodiment. Computing environment 100 contains an example of an environment for the execution of at least some of the computer code involved in performing the inventive methods, such as a robotic scrubbing program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include robotic devices, laser beam emitting devices, material spraying devices, profilometers, contact profilometers, and/or laser scanning microscopes.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

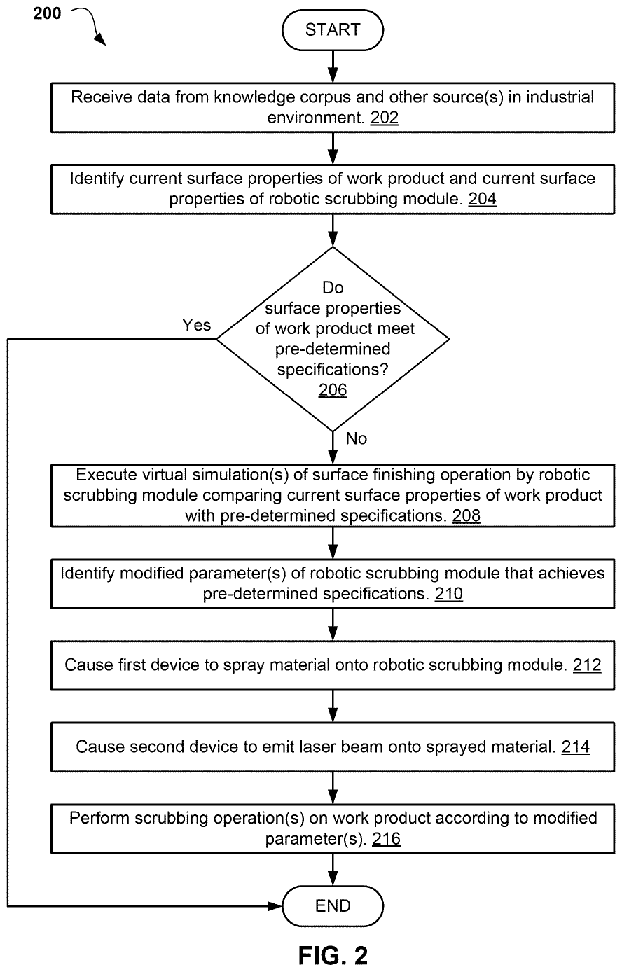

According to the present embodiment, the robotic scrubbing program 150 may be a program capable of receiving data from a knowledge corpus and at least one other source in an industrial environment, identifying one or more modified parameters of the robotic scrubbing module that achieves pre-determined specifications of a surface profile of a work product based on one or more executed simulations, and causing at least one first device to spray a material onto the robotic scrubbing module based on a comparison between current surface properties of the work product with the pre-determined specifications of the surface profile of the work product. Furthermore, notwithstanding depiction in computer 101, the robotic scrubbing program 150 may be stored in and/or executed by, individually or in any combination, end user device 103, remote server 104, public cloud 105, and private cloud 106. The robotic scrubbing method is explained in further detail below with respect to FIG. 2. It may be appreciated that the examples described below are not intended to be limiting, and that in embodiments of the present invention the parameters used in the examples may be different.

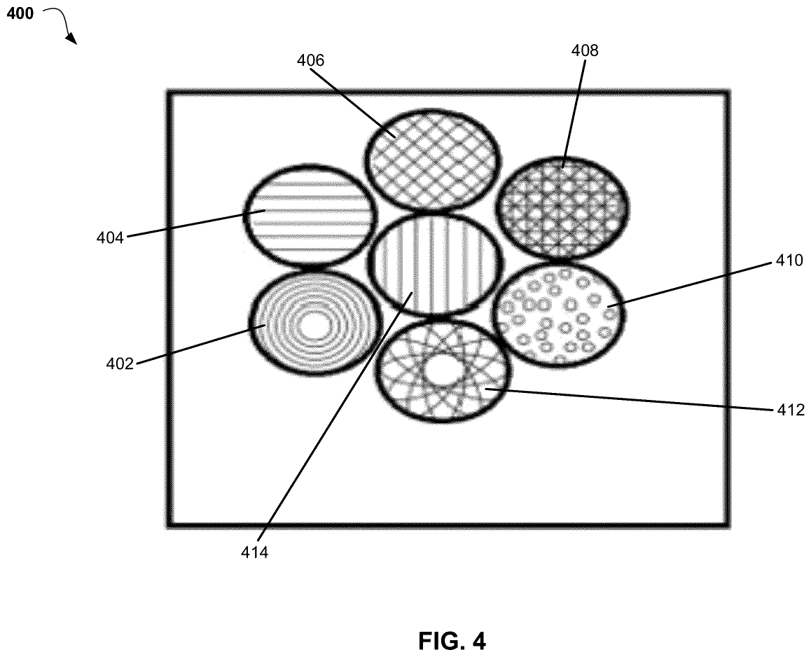

Referring now to FIG. 2, an operational flowchart for dynamically adapting a robotic scrubbing module in a dynamic robotic scrubbing module adaptation process 200 is depicted according to at least one embodiment. At 202, the robotic scrubbing program 150 receives the data from the knowledge corpus and the at least one other source in the industrial environment. The industrial environment may be an assembly line where a work product is constructed in stages. For example, the industrial environment may be an automobile manufacturing plant. The data from the knowledge corpus may include, but is not limited to, different types of surface profiles of the robotic scrubbing module (illustrated in FIG. 4), material types of the work product, hardness of the work product material, current surface parameters, required surface parameters, scrubber material properties, grit level (e.g., roughness) of the robotic scrubbing module, and/or rotational speed of the robotic scrubbing module during scrubbing operations. The data in the knowledge corpus may cover a wide range of work product types and scenarios from different types of scrubbing activities. For example, the data may include information about automobile parts and/or construction materials (e.g., piping or other metal components).

The at least one other source may include, but is not limited to, a surface profilometer, a contact profilometer, a laser scanning microscope, and/or a scattered light reflection module. For example, the scattered light reflection module may identify the surface profile of the robotic scrubbing module and the surface profile of the work product. The data is collected in real-time and historically. The historical data may be input into and retrieved from the knowledge corpus, such as remote database 130. In this manner, the real-time data becomes the historical data upon being input into the knowledge corpus. The at least one other source may provide numerical values that represent the roughness parameters of the surface of the work product, such as Ra (average roughness), Rz (maximum height of the roughness profile), and/or Rq (root mean squared roughness).

The robotic scrubbing program 150 may pre-process the gathered data to ensure quality and consistency. The pre-processing may include handling missing values, removing outliers, and/or normalizing the data for better model performance. The pre-processed data may then be fed to classification machine learning model. The classification machine learning model may correlate the surface profiles of the robotic scrubbing module with the resultant surface finish of the work product, which may be stored in the knowledge corpus. For example, the correlation may indicate the robotic scrubbing module having a grit level of 8 resulted in a work product having a smoother surface finish than a robotic scrubbing module having a grit level of 5.

According to at least one embodiment, a mathematical model may relate the surface finish of the work product to various parameters. The mathematical model is as follows: SF=a*F*P*V, where SF represents the surface finish of the work product, a is a constant that accounts for material properties, robotic scrubbing module characteristics, and environmental conditions, F represents the force applied during scrubbing (dependent on factors such as the weight of the robotic scrubbing module, pressure exerted of the work product surface, and scrubbing technique), P represents the speed or frequency of the scrubbing motion (accounting for parameters such as rotational speed and/or oscillating frequency of the robotic scrubbing module), and V represents the velocity of the scrubbing motion (accounting for speed at which the robotic scrubbing module moves over the work product surface). Accordingly, since SF is directly proportional to a, F, P, and V, a higher numerical value for SF may indicate a smoother surface finish.

Then, at 204, the robotic scrubbing program 150 identifies the current surface properties of the work product and the current surface properties of the robotic scrubbing module. The current surface properties of the work product and the current surface properties of the robotic scrubbing module are identified based on the data. As described above with respect to step 202, the real-time data may include the surface profile of the robotic scrubbing module and the surface profile of the work product from the at least one other source. It may be appreciated that the terms “properties” and “profiles” are used interchangeably herein. Using scattered light, the current surface properties of the work product and the current surface properties of the robotic scrubbing module may be identified.

According to at least one embodiment, the current surface properties of the work product and the current surface properties of the robotic scrubbing module may include the current specifications (e.g., length, width, height) of the robotic scrubbing module and the current specifications (e.g., length, width, height) of the work product. For example, the current specifications of the work product may be 10 cm×15 cm×20 cm and the current specifications of the robotic scrubber module may be 3 cm×5 cm×7 cm.

According to at least one other embodiment, in addition to the current dimensions, the current surface properties of the work product and the current surface properties of the robotic scrubbing module may include the current grit level (e.g., roughness) of the robotic scrubbing module and the current grit level (e.g., roughness) of the work product. The grit level may be a numerical value, where a higher grit level indicates a higher roughness. For example, where the grit level is a number between 1 and 10, a robotic scrubbing module having a grit level of 8 would be rougher than a robotic scrubbing module having a grit level of 5.

According to at least one further embodiment, the current surface properties of the robotic scrubbing module may include a pattern of the surface of the robotic scrubbing module, described in further detail below with respect to the description of FIG. 4.

Next, at 206, the robotic scrubbing program 150 determines whether the current surface properties of the work product meet the pre-determined specifications of the surface profile of the work product. The pre-determined specifications of the surface profile of the work product may be made based on industry standards and/or specific functional or aesthetic requirements of the work product. The pre-determined specifications may take into account the dimensions as well as the grit level of the work product. The determination may include using image analysis of the work product on the assembly line to identify the dimensions of the work product. The dimensions of the work product may then be compared with the pre-determined specifications. When the dimensions of the work product on the assembly line do not meet the pre-determined specifications, the determination may be made that the current surface properties of the work product do not meet the pre-determined specifications of the surface profile of the work product. For example, where the current dimensions of the work product are 10 cm×15 cm×20 cm, and the pre-determined specifications are 8 cm×13 cm×18 cm, the determination may be made that the current surface properties of the work product do not meet the pre-determined specifications.

Based on determining the current surface properties of the work product do not meet the pre-determined specifications (step 206, “No” branch), the dynamic robotic scrubbing module adaptation process 200 proceeds to step 208 to execute the one or more virtual simulations of the surfacing finishing operation by the robotic scrubbing module. Based on determining the current surface properties of the work product do meet the pre-determined specifications (step 206, “Yes” branch), dynamic robotic scrubbing module adaptation process 200 ends.

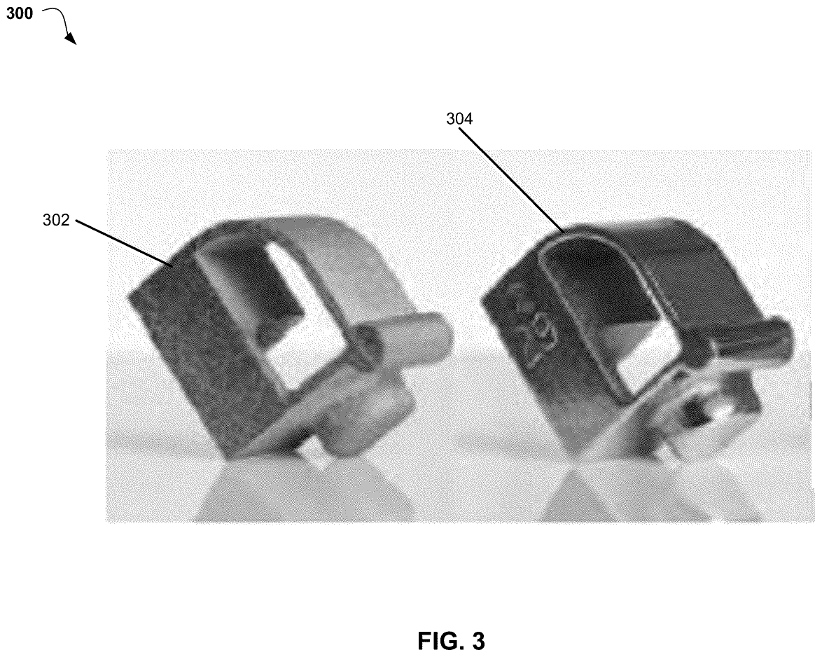

Then, at 208, the robotic scrubbing program 150 executes the one or more virtual simulations of the surface finishing operation by the robotic scrubbing module. As used herein, “surface finishing operation” means the scrubbing (e.g., polishing) the robotic scrubbing module performs on the work product to obtain the pre-determined specifications. The one or more virtual simulations include comparing the current surface properties of the work product with the pre-determined specifications. Specifically, during the one or more virtual simulations, the current grit level of the work product may be compared with the desired grit level in the pre-determined specifications, as illustrated in FIG. 3. Comparing the current surface properties of the work product with the pre-determined specifications may include computing a deviation between a current roughness value of the work product and a target roughness value of the work product. For example, where the current roughness value is 8 and the target roughness value is 5, the deviation may be 3.

According to at least one embodiment, executing the virtual simulation may include performing a set of trial-and-error operations to identify a grit level of the robotic scrubbing module that achieves the pre-determined specifications in a least amount of time. The robotic scrubbing program 150 may initiate the trial-and-error operations by querying the knowledge corpus for the surface properties of the robotic scrubbing module that achieved the pre-determined specifications, since the knowledge corpus contains correlations between the surface profiles of the robotic scrubbing module and the resultant surface finish of the work product.

The surface finish SF may be inversely proportional to the grit level, since a higher surface finish value results in a lower roughness level.

For example, where the current roughness value of the work product is 8 and the target roughness value of the work product is 5, the robotic scrubbing program 150 may query the knowledge corpus for the grit level of the robotic scrubbing module that results in the target roughness value of 5 in the least amount of time. In this example, the grit level of the robotic scrubbing module may be 8. The deviation may be directly proportional to the grit level of the robotic scrubbing module. For example, where the current roughness value is 8 and the target roughness value is 3, the robotic scrubbing program 150 may query the knowledge corpus for the grit level of the robotic scrubbing module that results in the target roughness value of 3 in the least amount of time. In this example, the grit level of the robotic scrubbing module may be 10.

The grit level of the robotic scrubbing module obtained from the knowledge corpus may be the grit level used in the one or more virtual simulations. When the grit level of the robotic scrubbing module obtained from the knowledge corpus does not achieve the pre-determined specifications, the robotic scrubbing program 150 may select another grit level for the robotic scrubbing module. For example, where robotic scrubbing module having a grit level of 8 did not achieve the target roughness value of 5, the grit level of 8 may be changed to a grit level of 9 and an updated virtual simulation may be executed where the robotic scrubbing module has a grit level of 9. These steps may be repeated until the target roughness value is achieved.

According to at least one other embodiment, the one or more virtual simulations may include adapting F, P, and/or V to achieve the pre-determined specifications. For example, where the current roughness value of the work product is 8 and the target roughness value of the work product is 5, the robotic scrubbing program 150 may increase F, P, and/or V such that surface finish SF is higher, which results in a lower grit level. In another example, where the current roughness value of the work product is 5 and the target roughness value of the work product is 8, the robotic scrubbing program 150 may decrease F, P, and/or V such that surface finish SF is lower, which results in a higher grit level.

Next, at 210, the robotic scrubbing program 150 identifies the one or more modified parameters of the robotic scrubbing module that achieves the pre-determined specifications. The one or more modified parameters are identified based on the one or more virtual simulations.

According to at least one embodiment, the one or more modified parameters may be a change in the current surface properties of the robotic scrubbing module. The one or more modified parameters of the robotic scrubbing module may include a modified grit level of the robotic scrubbing module. For example, where the one or more virtual simulations indicate the grit level of the robotic scrubbing module should be 8 and the current grit level is 5, the modified grit level may be 8. In another example, where the one or more virtual simulation indicate the grit level of the robotic scrubbing module should be 10 and the current grit level is 8, the modified grit level may be 10.

According to at least one other embodiment, identifying the one or more modified parameters may include identifying a first modified parameter of the one or more modified parameters for a first stage of the one or more scrubbing operations and identifying a second modified parameter of the one or more modified parameters for a second stage of the one or more scrubbing operations. Since industrial manufacturing often involves creating a work product in multiple stages, it may be desirable to select the parameters for each stage individually. For example, the first modified parameter in the first stage may be a grit level of 8 for the robotic scrubbing module and the second modified parameter in the second stage may be a grit level of 10 for the robotic scrubbing module.

According to at least one further embodiment, the one or more modified parameters of the robotic scrubbing module may include a modified force, rotational speed, and/or velocity at which the robotic scrubbing module performs the one or more scrubbing operations. For example, the modification may be an increase in F, P, and/or V such that surface finish SF is higher, which results in a lower grit level. In another example, the modification may be a decrease in F, P, and/or V such that surface finish SF is lower, which results in a higher grit level.

According to at least one other embodiment, the one or more modified parameters of the robotic scrubbing module may include a modification to the scrubbing material used. Depending on the desired grit level of the work product upon which the robotic scrubber module is operating, it may be desirable to perform the scrubbing with a particular material. For example, the particular material may include, but is not limited to, aluminum, nickel, copper, steel, and/or titanium.

Then, at 212, the robotic scrubbing program 150 causes the at least one first device to spray the material onto the robotic scrubbing module. The at least one first device sprays the material onto the robotic scrubbing module based on the comparison. The at least one first device may include a spray module of a robotic device. The robotic scrubbing program 150 may send a signal to a spray module of a robotic device to activate a spraying mechanism of the spray module. For example, the spray module may spray aluminum, nickel, copper, steel, and/or titanium onto the surface of the robotic scrubbing module. The amount of the material sprayed may be dependent upon the deviation between a current roughness value of the work product and the target roughness value of the work product.

For example, assume the current roughness value is 8 and the target roughness value is 5. The deviation may be 3. In a different example, assume the current roughness value is 8 and the target roughness value is 6. The deviation may be 2. The amount of material sprayed in the first example may be greater then in the second example, since more material may be needed to achieve the smoother surface finish SF.

Next, at 214, the robotic scrubbing program 150 causes the at least one second device to emit the laser beam onto the sprayed material. The at least one second device emits the laser beam based on the one or more modified parameters. The at least one second device may include a laser beam emitting device. The robotic scrubbing program 150 may send a signal to the laser beam emitting device, which may supply energy to the medium of the laser beam emitting device, which then amplifies light through stimulated emission. The at least one first device and the at least one second device may collaborate with each other to achieve the pre-determined specifications.

For example, where the modified grit level is 8, the laser beam may be applied to the sprayed material to achieve the grit level of 8. In another example, where the modified grit level is 10, the laser beam may be applied to the sprayed material to achieve the grit level of 10.

According to at least one other embodiment, where the parameters are selected for each stage of multiple stages, the laser beam may be applied to the sprayed material to achieve the grit level in each stage. For example, where the grit level is 8 in the first stage and 10 in the second stage, the laser beam may be applied to the sprayed material to achieve the grit level of 8 in the first stage, and then upon completing the first stage by the robotic scrubbing module, the at least one first device may spray additional material onto the surface of the robotic scrubbing module, and the laser beam may be applied to the additional sprayed material to achieve the grit level of 10 in the second stage, and so on.

Then, at 216, the robotic scrubbing program 150 performs the one or more scrubbing operations on the work product according to the one or more modified parameters. The one or more scrubbing operation may involve polishing the work product to achieve the pre-determined specifications.

According to at least one embodiment, where the one or more modified parameters include the modified grit level of the robotic scrubbing module, the robotic scrubbing module may perform the one or more scrubbing operations on the work product at the modified grit level. For example, where the modified grit level is 8, the robotic scrubbing module may have a grit level of 8 when performing the one or more scrubbing operations.

According to at least one other embodiment, where the one or more modified parameters include the first modified parameter for the first stage and the second modified parameter for the second stage, the robotic scrubbing module may perform the one or more scrubbing operations on the work product at the first modified parameter and the second modified parameter. For example, where the first modified parameter is a grit level of 8 and the second modified parameter isa grit level of 10, the robotic scrubbing module may have a grit level of 8 for the first stage and a grit level of 10 for the second stage.

According to at least one further embodiment, where the one or more modified parameters include a modified force, rotational speed, and/or velocity at which the robotic scrubbing module performs the one or more scrubbing operations, the robotic scrubbing module may perform the one or more scrubbing operations on the work product at the modified force, rotational speed, and/or velocity. For example, where the original velocity is 5 meters per second (m/s) and the modified velocity is 8 m/s, the robotic scrubbing module may perform the one or more scrubbing operations at 8 m/s.

According to at least one other embodiment, where the one or more modified parameters include the modified material, the robotic scrubbing module may perform the one or more scrubbing operations on the work product with the modified material. For example, where the original material is nickel and the modified material is titanium, the robotic scrubbing module may perform the one or more scrubbing using the titanium.

Referring now to FIG. 3, an exemplary diagram 300 depicting a work product 302, 304 before and after polishing is shown according to at least one embodiment. In the diagram 300, the first work product 302 may have the current surface properties and the second work product 304 may have the pre-determined specifications of the surface profile. During the one or more virtual simulations, the robotic scrubbing program 150 may use the image of the first work product 302 and the second work product 304 to compute the deviation between the current surface properties and the target surface properties.

Referring now to FIG. 4, an exemplary diagram 400 depicting a knowledge corpus containing various surface profiles 402-414 of the robotic scrubbing module is shown according to at least one embodiment. In the diagram 400, the first surface profile 402 may be concentric circles. The second surface profile 404 may be a series of horizontal lines. The third surface profile 406 may be a series of intersecting lines forming a diamond shape. The fourth surface profile 408 may be a series of intersecting lines forming a triangular shape. The fifth surface profile 410 may be substantially circular protrusions extending from a flat surface. The sixth surface profile 412 may be a series of intersecting curved lines forming a web-like pattern. The seventh surface profile 414 may be a series of vertical lines. The various surface profiles 402-414 may be used to achieve the pre-determined specifications of the second work product 304 described in FIG. 3 above.

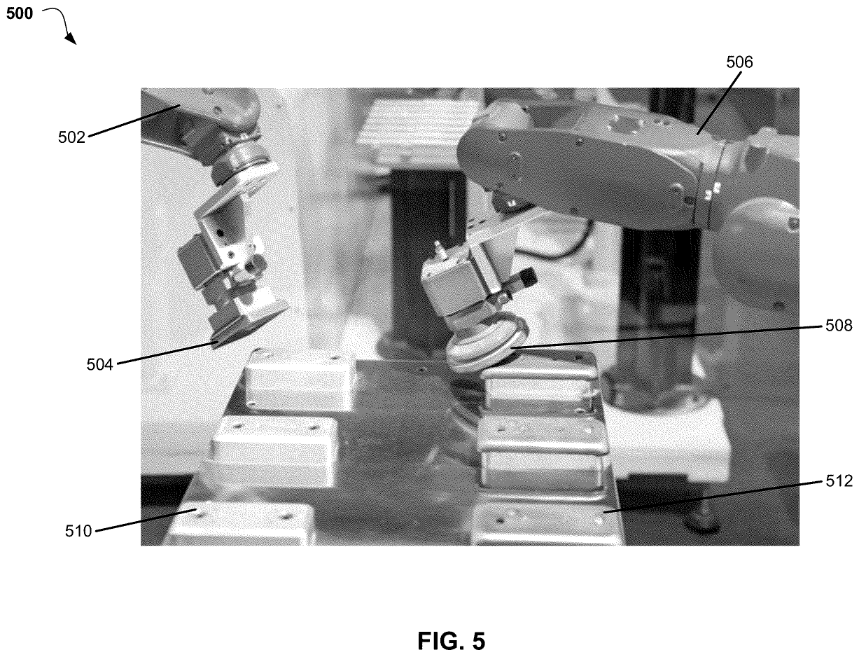

Referring now to FIG. 5, an exemplary diagram 500 depicting the robotic scrubbing module 504, 508 polishing the work product 510, 512 is shown according to at least one embodiment. In the diagram 500, the first robotic device 502 may have a first robotic scrubbing module 504 and the second robotic device 506 may have the second robotic scrubbing module 508. The first robotic scrubbing module 504 may have substantially a square shape while performing the one or more scrubbing operations on a first work product 510. The second robotic scrubbing module 508 may have substantially a circular shape while performing the one or more scrubbing operations on a second work product 512.

It may be appreciated that FIGS. 2, 3, 4, and 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-based method of dynamically adapting a robotic scrubbing module, the method comprising:
receiving data from a knowledge corpus and at least one other source in an industrial environment;
identifying current surface properties of a work product and current surface properties of a robotic scrubbing module based on the data;
determining whether the current surface properties of the work product meet pre-determined specifications of a surface profile of the work product;
based on determining the current surface properties of the work product do not meet the pre-determined specifications, executing one or more virtual simulations of a surface finishing operation by the robotic scrubbing module, wherein the one or more virtual simulations compare the current surface properties of the work product with the pre-determined specifications;
identifying one or more modified parameters of the robotic scrubbing module that achieves the pre-determined specifications based on the one or more virtual simulations;
causing at least one first device to spray a material onto the robotic scrubbing module based on the comparison; and
causing at least one second device to emit a laser beam onto the sprayed material to modify a grit level of the robotic scrubbing module according to the identified one or more modified parameters.

2. The computer-based method of claim 1, further comprising:
performing one or more scrubbing operations on the work product according to the identified one or more modified parameters, wherein the at least one first device and the at least one second device collaborate with each other to achieve the pre-determined specifications.

3. The computer-based method of claim 1, wherein the identified one or more modified parameters of the robotic scrubbing module include the modified grit level of the robotic scrubbing module.

4. The computer-based method of claim 1, wherein the identified one or more modified parameters of the robotic scrubbing module include a modified force, rotational speed, and velocity at which the robotic scrubbing module performs the one or more scrubbing operations.

5. The computer-based method of claim 1, wherein identifying the one or more modified parameters further comprises:
identifying a first modified parameter of the one or more modified parameters for a first stage of the one or more scrubbing operations and identifying a second modified parameter of the one or more modified parameters for a second stage of the one or more scrubbing operations.

6. The computer-based method of claim 1, wherein comparing the current surface properties of the work product with the pre-determined specifications further comprises:
computing a deviation between a current roughness value of the work product and a target roughness value of the work product.

7. The computer-based method of claim 1, wherein executing the one or more virtual simulations further comprises:
performing a set of trial-and-error operations to identify the grit level of the robotic scrubbing module that achieves the pre-determined specifications in a least amount of time.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving data from a knowledge corpus and at least one other source in an industrial environment;
identifying current surface properties of a work product and current surface properties of a robotic scrubbing module based on the data;
determining whether the current surface properties of the work product meet pre-determined specifications of a surface profile of the work product;
based on determining the current surface properties of the work product do not meet the pre-determined specifications, executing one or more virtual simulations of a surface finishing operation by the robotic scrubbing module, wherein the one or more virtual simulations compare the current surface properties of the work product with the pre-determined specifications;
identifying one or more modified parameters of the robotic scrubbing module that achieves the pre-determined specifications based on the one or more virtual simulations;
causing at least one first device to spray a material onto the robotic scrubbing module based on the comparison; and
causing at least one second device to emit a laser beam onto the sprayed material to modify a grit level of the robotic scrubbing module according to the identified one or more modified parameters.

9. The computer system of claim 8, the method further comprising:
performing one or more scrubbing operations on the work product according to the identified one or more modified parameters, wherein the at least one first device and the at least one second device collaborate with each other to achieve the pre-determined specifications.

10. The computer system of claim 8, wherein the identified one or more modified parameters of the robotic scrubbing module include the modified grit level of the robotic scrubbing module.

11. The computer system of claim 8, wherein the identified one or more modified parameters of the robotic scrubbing module include a modified force, rotational speed, and velocity at which the robotic scrubbing module performs the one or more scrubbing operations.

12. The computer system of claim 8, wherein identifying the one or more modified parameters further comprises:
identifying a first modified parameter of the one or more modified parameters for a first stage of the one or more scrubbing operations and identifying a second modified parameter of the one or more modified parameters for a second stage of the one or more scrubbing operations.

13. The computer system of claim 8, wherein comparing the current surface properties of the work product with the pre-determined specifications further comprises:
computing a deviation between a current roughness value of the work product and a target roughness value of the work product.

14. The computer system of claim 8, wherein executing the one or more virtual simulations further comprises:
performing a set of trial-and-error operations to identify the grit level of the robotic scrubbing module that achieves the pre-determined specifications in a least amount of time.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving data from a knowledge corpus and at least one other source in an industrial environment;
identifying current surface properties of a work product and current surface properties of a robotic scrubbing module based on the data;
determining whether the current surface properties of the work product meet pre-determined specifications of a surface profile of the work product;
based on determining the current surface properties of the work product do not meet the pre-determined specifications, executing one or more virtual simulations of a surface finishing operation by the robotic scrubbing module, wherein the one or more virtual simulations compare the current surface properties of the work product with the pre-determined specifications;
identifying one or more modified parameters of the robotic scrubbing module that achieves the pre-determined specifications based on the one or more virtual simulations;
causing at least one first device to spray a material onto the robotic scrubbing module based on the comparison; and
causing at least one second device to emit a laser beam onto the sprayed material to modify a grit level of the robotic scrubbing module according to the identified one or more modified parameters.

16. The computer program product of claim 15, the method further comprising:
performing one or more scrubbing operations on the work product according to the identified one or more modified parameters, wherein the at least one first device and the at least one second device collaborate with each other to achieve the pre-determined specifications.

17. The computer program product of claim 15, wherein the identified one or more modified parameters of the robotic scrubbing module include the modified grit level of the robotic scrubbing module.

18. The computer program product of claim 15, wherein the identified one or more modified parameters of the robotic scrubbing module include a modified force, rotational speed, and velocity at which the robotic scrubbing module performs the one or more scrubbing operations.

19. The computer program product of claim 15, wherein identifying the one or more modified parameters further comprises:
identifying a first modified parameter of the one or more modified parameters for a first stage of the one or more scrubbing operations and identifying a second modified parameter of the one or more modified parameters for a second stage of the one or more scrubbing operations.

20. The computer program product of claim 15, wherein comparing the current surface properties of the work product with the pre-determined specifications further comprises:
computing a deviation between a current roughness value of the work product and a target roughness value of the work product.
